(19) United States
(12) Patent Application Publication
(10) Pub. No.: US 2007/0062579 A1
(43) Pub. Date: Mar. 22, 2007

(54) AIR TRANSFER TUBE

(76) Inventor: Michelle Leidenheimer, Blue Spring, MO (US)

Correspondence Address: HOWARD M COHN;PATENT ATTORNEY LLC, 21625 CHAGRIN BLVD #220, CLEVELAND, OH, 44122, US

(21) Appl. No.: 11/534,087

(22) Filed: Sep. 21, 2006

Related U.S. Application Data
(60) Provisional application No. 60/596,417, filed on Sep. 22, 2005.

(51) Int. Cl. F16K 15/20

(52) U.S. Cl. 137/231

(57) ABSTRACT

An air transfer tube for transferring air from an inflated tire to a deflated tire is constructed of a tube with a connector attached to either end. The connectors each are adapted to be removably secured to the tire valve stems of the inflated and deflated tires. A valve device within each of the connectors acts to close its respective connector when the connector is removed from the valve stem.

### CROSS-REFERENCE TO RELATED APPLICATIONS

This application claims the benefit of U.S. Provisional Patent Application No. 60/596,417 filed on Sep. 22, 2005 which is incorporated herein by reference.

### BACKGROUND OF THE INVENTION

The present invention relates to devices and methods, e.g., to transfer compressed air from an inflated tire to a tire in need of inflation. Many load carrying devices, such as vehicles, carts, and wheel borrows, employ pneumatic tires to provide smooth rolling over a variety of surfaces. A major difficulty with pneumatic tires has been providing pressurized air for inflation of the tires. Many solutions to the inflation problem have been devised, such as provision of pump stations, portable hand pumps, and portable pressurized gas canisters.

Typically, gas service stations provide customers with pressurized air through a hose from a pressurized canister filled by a motorized pump. As a motorist's tires slowly loose pressure, they can be periodically inflated to the proper pressure while stopped at a service station for fuel. If a tire suddenly went flat out on the road, a motorist can replace the flat tire with an inflated spare tire carried in the vehicle.

A need remains for simple and effective devices and methods to inflate a tire, in a situation such as on a road, when a spare tire or source of pressurized air is not available. It is desirable to have an inexpensive, light weight, easily stored device for inflation of tires and other gas filled objects. The present invention provides these and other benefits, as will be made evident in the disclosure that follows.

### SUMMARY OF THE INVENTION

According to the present invention, there is disclosed a flexible gas transfer tube, comprising a tube with a first connector attached to a first end of the tube and a second connector attached to a second end of the tube. The first and second connectors each have structure for removably securing the first and second connectors to first and second tire valve stems of first and second tires, respectively. Valves in each of the first and second connectors are adapted to close the first and second connectors when the first and second connectors are disconnected from the first and second tire valve stems.

Further according to the present invention, the valves in the connectors are each a one way valve that substantially prevents passage of gas through the connector when the connector is disconnected from the tire valve stem. The one way valve can be a ball and seat valve or a flapper valve.

Still further according to the present invention, there is structure for removably securing the first and second connectors to first and second tire valve stems. The structure includes a movable gate structure that extends through a wall of the connector for securing a valve stem in the connector. The movable gate structure includes a spring biased gate operator to maintain the gate structure in a closed, locking position. The spring biased gate operator includes a lever to move the gate structure from the closed, locking position to an open position to enable the insertion of a valve stem.

Also according to the present invention, the flexible transfer tube is constructed of rubber, plastic, silicone, polypropylene, fluorocarbon polymer, or polyethylene. The transfer tube has a supporting braid of nylon or Mylar fibers to enhance strength and resistance to blow out.

Still further according to the present invention, the gas transfer tube can include an on-off valve in the tube between the first and second connectors.

Also according to the present invention, components for removably securing the first and second connectors to first and second tire valve stems can comprise first and second rotatable collars, respectively, with internal threads incorporated on an inside surface of the collars to enable a screw-on attachment of the connectors to the tire valve stems.

According to the present invention, a method of inflating a deflated tire comprising the steps of providing a transfer tube having first and second connectors on either end, wherein the first and second connectors has first and second biased closed valves with first and second extension pins, respectively; attaching the first connector to a first valve stem of a first tire to be inflated tire whereby the first extension pin opens a biased closed stem valve in the first valve stem and the first valve stem opens the first biased closed valve of the first connector; and attaching the second connector to the second valve stem of a second tire that is inflated tire whereby the second extension pin opens a biased closed stem valve in the second valve stem and the second valve stem opens the second biased closed valve of the second connector whereby compressed gas from the second tire flows through the tube to inflate the second tire.

Also according to the present invention, the method includes the step of disconnecting the first connector from the first valve stem of the first tire after it is sufficiently inflated tire whereby the first biased closed stem valve in the first valve stem closes and the first biased closed valve of the first connector closes.

Yet further, according to the present invention, the method includes the step of disconnecting the second connector from the second valve stem of the second tire after the first tire is sufficiently inflated tire whereby the second biased closed stem valve in the second valve stem closes and the second biased closed valve of the second connector closes.

Still further, according to the present invention, the method includes the step of removably securing the first and second connectors to the first and second tire valve stems of first and second tires, respectively. The method can include removably securing the first and second connectors to a threaded section of the first and second tire valve stems.

Also according to the present invention, the method includes the allowing compressed gas, such as air or nitrogen to flow through the transfer tube.

### BRIEF DESCRIPTION OF THE DRAWINGS

The structure, operation, and advantages of the present invention will become further apparent upon consideration of the following description taken in conjunction with the accompanying figures (Figs.). The figures are intended to be illustrative, not limiting.

Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, often both reference numerals and legends (labels, text descriptions) may be used to identify elements. If legends are provided, they are intended merely as an aid to the reader, and should not in any way be interpreted as limiting.

FIG. 1 is a plan view of the air transfer tube in accordance with the present invention;

FIG. 2 is a plan view of a second embodiment of the air transfer tube in accordance with the present invention;

FIG. 3 is a cross-sectional view of a connector at one end of an air transfer tube removably attached to a valve stem of a tire;

FIG. 4 shows the gas transfer tube being used to provide for air flow between two tires in accordance with the present invention;

FIG. 5 shows an alternative embodiment of a connector.

### DETAILED DESCRIPTION OF THE PREFERRED EMBODIMENTS

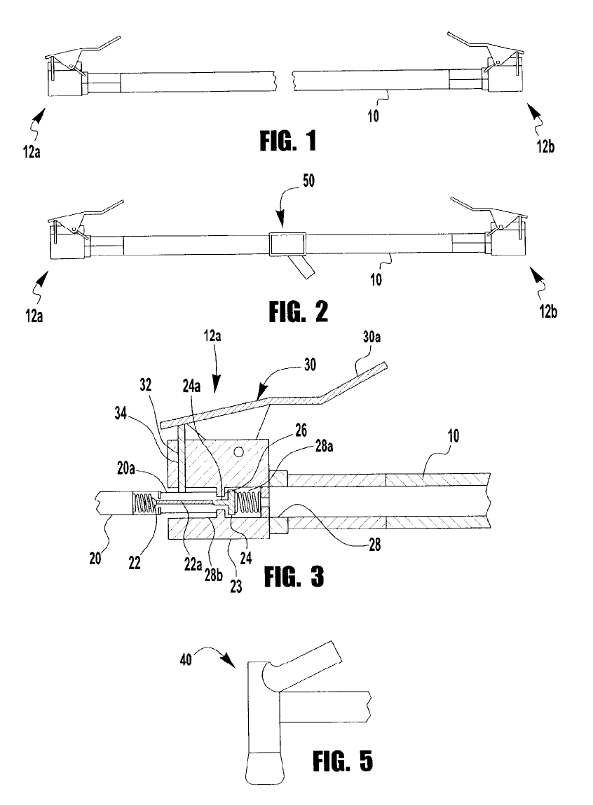

FIG. 1 illustrates the basic construction of an air transfer tube 10 according to the present invention. The air transfer tube 10 includes a flexible tube 10 with sealable first and second end connectors 12a, 12b attached at opposite ends thereof. The end connectors 12a, 12b are each adapted to removably secure the first and second connectors to first and second tire valve stems of first and second tires, as discussed herein after.

Preferably, the air transfer tube 10 is flexible to allow manipulation of the tube to easily seal the end connectors 12a, 12b onto tire valve stems presented at almost any angle. The tube 10 is preferably fabricated from flexible materials such as rubber, plastic, silicone, polypropylene, fluorocarbon polymer, polyethylene. The tube 10 can beneficially include a supporting net or braid of nylon or Mylar fibers to enhance strength and resistance to blow out. The tube 10 can be any appropriate length, such as about 25 feet. It is, however, within the terms of the present invention to construct the tube 10 of a rigid material for some applications.

At opposite ends of the transfer tube 10 are sealable end connectors 12a, 12b that can both mount onto tire valve stems and open the valves in the valve stems to allow for the flow of compressed air there through. While compressed air is commonly in tires, it is also within the terms of the invention to use the transfer tube 10 for any gas such as nitrogen.

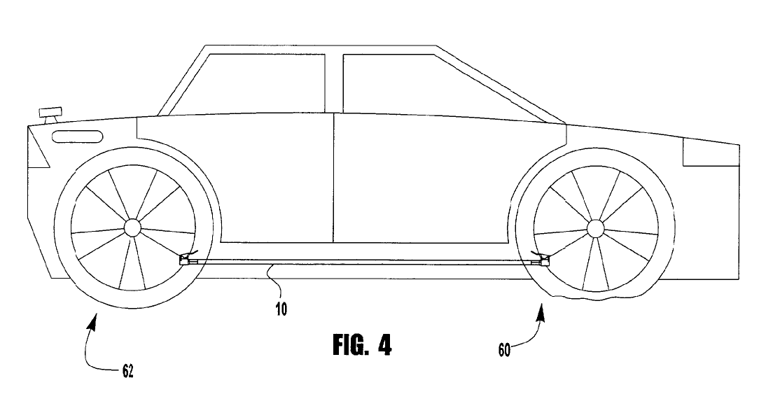

Referring to FIG. 3, there is shown an enlarged cross-sectional view of end connector 12a attached to a conventional tire valve stem 20. The tire valve stem 20 has a spring biased valve 22 with an extension pin 22a extending into the threaded end portion 20a of the valve stem.

The end connector 12a has a body 23 containing a biased valve 24 that is pressed against a valve seat 26 formed in a flow passage 28 extending through the connector body 23.

Valve 24 is located in a rear chamber 28a of the flow passage 28. Valve 24 includes a pin-like extension 24a that extends into a front chamber 28b of connector body 23. Front chamber 28b is adapted to receive the threaded end portion 20a of the valve stem 20.

A movable gate structure 30 is pivotably mounted to the connector body 23 and includes a plate 32 received within a slot 34 extending through the connector body 23. The free end of the plate 32 preferably has a semicircular shape so that it can engage the threads of the threaded end 20a of valve stem 20. The gate structure 30 includes a finger operator or lever 30a and is biased in the closed position where the plate 32 is pressed into the slot 34.

In operation, the gate structure 30 is opened so that the plate 32 is withdrawn from chamber 28b. Then a valve stem 20 is inserted into the chamber 28b so that the extension 24a of valve 24 presses against extension pin 22a and forces spring biased valve 22 open. At the same time, the valve 24 is moved away from it's valve seat 28a so that the pressurized gas or air can flow from the tire, through the valve stem 20, then through connector 12a and into the flexible tube 10 whereby any loss of air into the environment is prevented while connecting or disconnecting. The gate structure 30 is allowed to bias closed so that the valve stem 20 is secured within the connector 12a.

Once the pressurized gas flow through the tube 10, the connector is disconnected from the valve stem by first opening the gate structure 30 so that the plate 32 is withdrawn away from the threaded section of the valve stem. Then the connector 12a is pulled away from the valve stem causing the biased stem valve in the valve stem to close and the biased closed valve of the connector to close.

The end connectors 12a, 12b can be of any conventional design and include a pin for opening the check valve in the tire valve stem. For example, while a press on connector is illustrated, it is also within the terms of the invention to use freely rotatable collars 40 as shown in FIG. 5. Internal threads are incorporated on an inside surface of the end connectors to enable a screw-on attachment of the threaded portion of the tire valve stems. The rotatable collars can include an outer, knurled surface for a better grip by the user during transfer operations. The connector collars can have inside threads that functionally receive the outside threads of the tire valve stems to hold the connectors to the outer threads on the valve stems. By turning the connector threads onto the valve stem threads, the conventional seals provided in the connector can be pressed onto the mouth of the tire valve stem and a valve pin within the connectors can open the tire stem valve.

FIG. 2 illustrates the identical tube as FIG. 1 with the addition of an on-off valve 50. When the on-off valve 50 is closed, the connectors 12a, 12b can be secured to the tire valve stems of two tires. Once the connectors are mounted to the valve stems, the on-off valve 50 can be opened so that the air flows from the more inflated tire to the less inflated tire. Once the tires are evenly inflated, the on-off valve 50 can be closed again and the connectors 12a, 12b can be removed from the valve stems.

FIG. 4 illustrates the present invention in use. The front tire 60 of an automobile is shown as flat. Using the air transfer tube 10, the air can be transferred from an inflated tire, such as the rear tire 62 to the uninflated tire 60. Using the air transfer tube 10, with or without the on-off valve 50, the connectors are secured onto the valve stems of the tires 60, 22. Then the air will flow from the inflated to the deflated tire. If necessary, the connector can be a Schrader and a Presto Valve can be inserted within the connector if necessary.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A gas transfer tube, comprising:
a tube with a first connector attached to a first end of the tube and a second connector attached to a second end of the tube;
the first and second connectors each having means for removably securing the first and second connectors to first and second tire valve stems of first and second tires, respectively; and
valve means in each of said first and second connectors to close the first and second connectors when the first and second connectors are disconnected from the first and second tire valve stems.

2. The gas transfer tube of claim 1 wherein the valve means is a one way valve that substantially prevents passage of gas through the connector when the connector is disconnected from the tire valve stem.

3. The gas transfer tube of claim 2 wherein the one way valve is a ball and seat valve or a flapper valve.

4. The gas transfer tube of claim 2 wherein the means for removably securing the first and second connectors to first and second tire valve stems comprises:
a movable gate structure that extends through a wall of the connector for securing a valve stem in the connector.

5. The gas transfer tube of claim 4 wherein the movable gate structure includes a spring biased gate operator to maintain the gate structure in a closed, locking position.

6. The gas transfer tube of claim 5 wherein the spring biased gate operator includes a lever to move the gate structure from the closed, locking position to an open position to enable the insertion of a valve stem.

7. The gas transfer tube of claim 1 wherein the transfer tube is flexible.

8. The gas transfer tube of claim 8 wherein the flexible transfer tube is constructed of rubber, plastic, silicone, polypropylene, fluorocarbon polymer, or polyethylene.

9. The gas transfer tube of claim 8 wherein the transfer tube has a supporting braid of nylon or Mylar fibers to enhance strength and resistance to blow out.

10. The gas transfer tube of claim 1 further including an on-off valve in the tube between the first and second connectors.

11. The gas transfer tube of claim 2 wherein the means for removably securing the first and second connectors to first and second tire valve stems comprises:
first and second rotatable collars, respectively, with internal threads incorporated on an inside surface of the collars to enable a screw-on attachment of the connectors to the tire valve stems.

12. A method of inflating a deflated tire comprising the steps of:
providing a transfer tube having first and second connectors on either end, wherein the first and second connectors has first and second biased closed valves, respectively, and first and second extension pins, respectively;
attaching the first connector to a first valve stem of a first tire to be inflated tire whereby the first extension pin opens a biased closed stem valve in the first valve stem and the first valve stem opens the first biased closed valve of the first connector;
attaching the second connector to the second valve stem of a second tire that is inflated tire whereby the second extension pin opens a biased closed stem valve in the second valve stem and the second valve stem opens the second biased closed valve of the second connector;
whereby gas from the second tire flows through the tube to inflate the second tire.

13. The method of claim 12 further including the step of disconnecting the first connector from the first valve stem of the first tire after it is sufficiently inflated tire whereby the first biased closed stem valve in the first valve stem closes and the first biased closed valve of the first connector closes.

14. The method of claim 13 further including the step of disconnecting the second connector from the second valve stem of the second tire after the first tire is sufficiently inflated tire whereby the second biased closed stem valve in the second valve stem closes and the second biased closed valve of the second connector closes.

15. The method of claim 12 further including the step of removably securing the first and second connectors to the first and second tire valve stems of first and second tires, respectively.

16. The method of claim 15 further including the step of removably securing the first and second connectors to a threaded section of the first and second tire valve stems.

17. The method of claim 12 wherein the gas flowing through the tube is air or nitrogen.

18. The method of claim 12 including the step of providing the transfer tube of a flexible material selected from the rubber, plastic, silicone, polypropylene, fluorocarbon polymer, or polyethylene.

19. The gas transfer tube of claim 18 including the step of providing the transfer tube with a supporting braid of nylon or Mylar fibers to enhance strength and resistance to blow out.
